(19) United States
(12) Patent Application Publication
(10) Pub. No.: US 2006/0139746 A1
(43) Pub. Date: Jun. 29, 2006

(54) Optical device for observing samples on a support, designed in particular for a cytometer

(76) Inventors: Michel Delaage, Marseille (FR); Pierre Delaage, Marseille (FR); Michel Lequime, Eguilles (FR); Jean-Michel Decaudin, Velaux (FR)

Correspondence Address: YOUNG & THOMPSON, 745 SOUTH 23RD STREET, 2ND FLOOR, ARLINGTON, VA, 22202, US

(21) Appl. No.: 10/530,660

(22) PCT Filed: Oct. 6, 2003
(86) PCT No.: PCT/FR03/02930

§ 371 Date: Nov. 14, 2005

(30) Foreign Application Priority Data
Oct. 8, 2002 (FR) 02/12473

(51) Int. Cl. G02B 21/00

(52) U.S. Cl. 359/368

(57) ABSTRACT

An optical device (12) includes a front surface located on the side of the sample to be observed and a rear surface oriented towards the elements for acquiring (18, 19) an image or a user. It further includes a combination of four aligned lenses. The lenses are arranged in the following sequence from the front rearwards: a plano-convex lens (28), a convexo-concave lens (30), a plano-concave lens (32) and a biconvex lens (34). The plano-concave (32) and the plano-convex lenses are respectively such that they each have a substantially planar surface and a concave surface or convex surface respectively. The invention is applicable to a cell analyzer.

The present invention relates to an optical device for the observation of specimens on a support, this device being adapted particularly for cytometry.

The present invention is more particularly adapted to a device such as disclosed in WO 01/88593 of the same applicant. A device of this type is used particularly for the rapid analysis of a large number of specimens disposed on a same support, for example a plate, these specimens being constituted for example by cells, in particular adherent, eukaryotic, prokaryotic, vegetable, etc. cells, or other objects, such as micro-particles or micro-deposits. The described device comprises a plate for positioning the support bearing the specimens, an observation objective, illumination means for at least a portion of the support, and means for acquiring an image of the outlet of the observation objective.

The support is generally present in the form of a plate comprising an assembly of adjacent wells each adapted to receive a specimen. This support is disposed on a positioning plate and is thus located in a plane perpendicular to the axis of the observation objective. This objective can be disposed above or below the support provided with wells. In the first case, the observation takes place directly above the specimen and in the second case it takes place through the lower surface of the support, through the bottom of each well. The positioning plate permits moving the support and holding it in a same plane perpendicular to the observation axis so as to bring successively each well opposite the observation objective.

The present invention thus finds application for example in the field of cytometry, which consists in placing cell cultures in optically transparent wells, subjecting them to chemical action and observing the development of the cells by fluorescence imagery. It is thus sought to evaluate the number and size of the living cells present in the cultures, the end result being to observe their reaction relative to the chemical actions. The number of cells is generally very large and the frequency of observation very high. This limits the possibility of observation and of counting by an operator. Automatic methods thus permit this counting and this measurement.

These constraints to carry out counting and measurement of the cells are numerous. It should be noted that the living cells are very small (their size is of the order of several microns) whilst the field of observation is very large (size of the order of several millimeters) relative to the size of these cells. It is thus necessary, whilst observing a large field, to be able to detect the elements of small size. Moreover, the number of fluorescent molecules per cell is low. Because of this, the light available to image the cells is generally weak, particularly compared to the light necessary to excite fluorescence. The optical system used must thus be able to convey and separate the light serving for the excitation of the fluorescence, from that resulting from the fluoresence.

To this technical constraints must also be added the economic constraints. For reasons of productivity, the analysis must take place rapidly. It is also necessary that the cost of the apparatus proposed be acceptable on the market.

In prior art cytometers, such as the one for example disclosed in WO 01/88593, the optics used is based on microscope optics and does not permit satisfying the constraints indicated above. However, the solution is generally used because of its low cost. With such optics, when the wells are wells of large size (up to 7, even 10 mm), it is necessary to take four images for a same well, these four images being then combined to reconstitute a single image. Of course, this process is at the cost of speed and productivity.

The present invention thus has for its object to provide an optical device which permits, under satisfactory conditions for ultimate analysis, being able, with a single image, to observe an entire well, even of large size. Of course, this optical device preferably has very high resolution, a large numerical opening and a wide spectrum capable of retrieving the fluorescence emission from ultraviolet to near infrared.

To this end, it provides an optical device adapted particularly for the observation of specimens on a support in the field of biology, comprising a front surface located on the specimen side, or the like, to be observed and a rear surface oriented toward the acquisition means of an image, for a user.

According to the invention, this observation device comprises a combination of four aligned lenses, and the lenses are disposed in the following order, from front to rear: a plano-convex lens, a divergent meniscal lens, a plano-concave lens and a bi-convex lens, the plano-concave and plano-convex lenses respectively being such that they each have on the one hand a substantially flat surface and on the other hand a concave or convex surface, respectively.

The optical device according to the invention has the advantage of providing a wide angular field which permits seeing an entire specimen in the case of the use of the device for the observation of specimens disposed in wells of culture plates. This arrangement of the optical device also permits having a wide numerical opening which makes this device a luminous device.

In a preferred embodiment, the lenses are grouped as two doublets, one front doublet with the plano-convex lens and the divergent meniscal lens, and a rear doublet with the plano-concave and bi-convex lenses.

In a preferred embodiment, the rear doublet is a cemented doublet for which the front radius of curvature of the bi-convex lens corresponds to the radius of curvature of the rear spherical surface of the plano-concave lens, and the two lenses of each doublet are made of material having different indices of refraction. There is thus in this embodiment a doublet (the rear doublet) which can be cemented.

The front doublet is itself for example an un-cemented doublet but it can also be a doublet un-cemented at the center but cemented about its periphery.

Preferably, the two lenses are located at the center of the optical device having an index of refraction greater than the index of refraction of the lenses located outside the optical device.

The present invention also provides a preferred embodiment in which:

the plano-convex lens has a rear face of which the radius of curvature is comprised between −30 and −32.5 mm and a front substantially flat surface, a diameter comprised between 15 and 20 mm as well as a thickness at the center comprised between 2 and 4 mm,

the divergent meniscal lens has a rear surface whose radius of curvature is comprised between −22.5 and −25 mm and a front surface whose radius of curvature is comprised between −17 and −18.5 mm, a diameter substantially equal to the diameter of the plano-convex lens, as well as a thickness at the center comprised between 1 and 2 mm,

the plano-concave lens has a rear surface whose radius of curvature corresponds to the radius of curvature of the front surface of the bi-convex lens, a diameter comprised between 22 and 26 mm as well as a thickness at the center comprised between 1 and 3.5 mm, and

the rear bi-convex lens has a front surface whose radius of curvature is comprised between −28 and −30 mm and a front surface whose radius of curvature is comprised between 28 and 30 mm, a diameter substantially identical to the diameter of the plano-convex lens, as well as a thickness at the center comprised between 4 and 7 mm,

the distance between the flat surfaces of the plano-concave lens and the plano-convex lens is comprised between 20 and 25 mm,

all the values indicated for this device can be multiplied by a same coefficient to obtain a similar device by homothetic transformation.

A device according to the invention can also comprise electroluminescent diodes disposed in a crown. The excitation light from the diodes passes about the cone of fluorescent light which will pass through the optical device to form the image. The lenses involved with the excitation light are coaxial to the optical device and are pierced by a central hole providing passage for this fluorescent light. These concentration lenses are either of conventional type, or of the Fresnel type.

The present invention also relates to an observation or analysis device of one or several specimens disposed on a support, particularly a plate, comprising an observation objective with at least one portion of a specimen on an axis of observation from one observation of the support, a positioning plate for the support adapted to ensure relative movement between the support and the axis of observation in a plane perpendicular to the axis of observation, whilst leaving free the vertical movement, illumination means for at least a portion of a specimen, and means for acquiring an image of the objective outlet, characterized in that the observation objective comprises an optical device as described above.

In such an observation device, the acquisition means of an image comprise for example an objective with a fixed focal length as the focusing optics. These acquisition means of an image can also comprise a zoom as the focusing optics so as to be able easily to change the size of the image and to use in an optimum manner the optical device according to the invention, but this is at the cost of troublesome labeling.

In one preferred embodiment, this observation device comprises, behind the optical device, a filtration device having variable spectral properties. This filtration device can in this case for example be a carousel with filters or else a liquid crystal filter, whose spectral properties are controllable electronically. There can also be preferably provided on the path of the fluorescent light a dichroic mirror returning a portion of this light toward the second observation means.

Other details and advantages of the present invention will become better apparent from the following description, given with reference to the accompanying schematic drawings, in which:

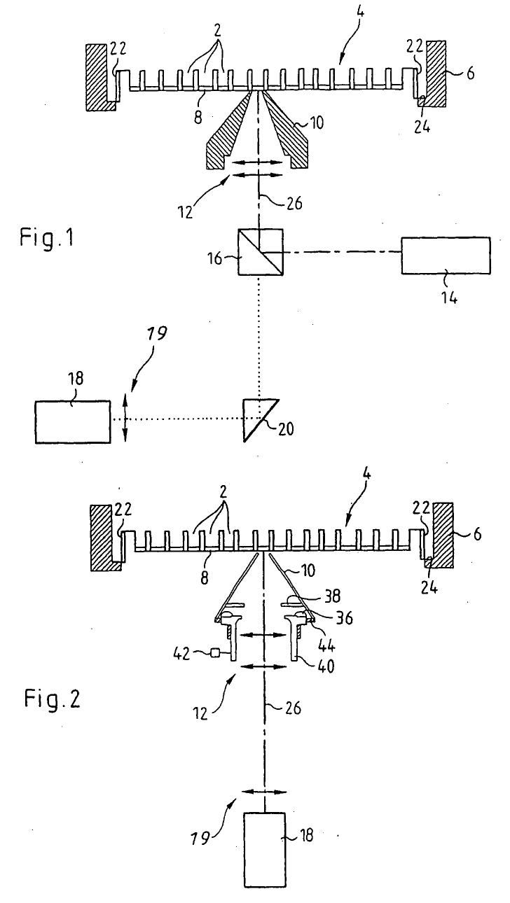

FIG. 1 shows schematically in cross-section a cell analyzer provided with an optical device according to the invention,

FIG. 2 corresponds to FIG. 1 for a modified embodiment of the cell analyzer provided with the same optical device,

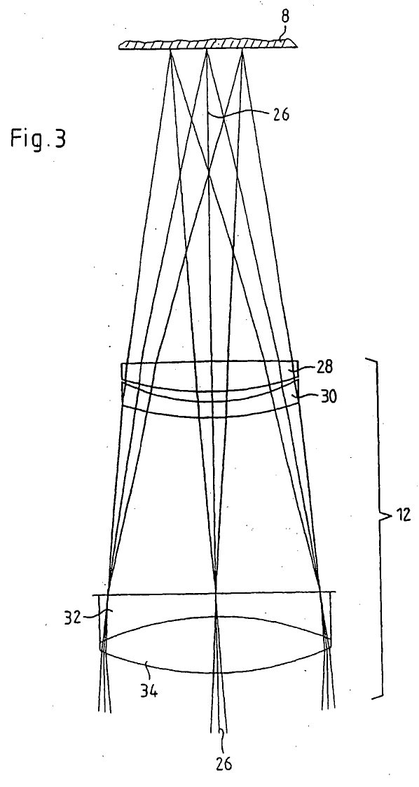

FIG. 3 shows in greater detail and on an enlarged scale the optical device according to the invention, and

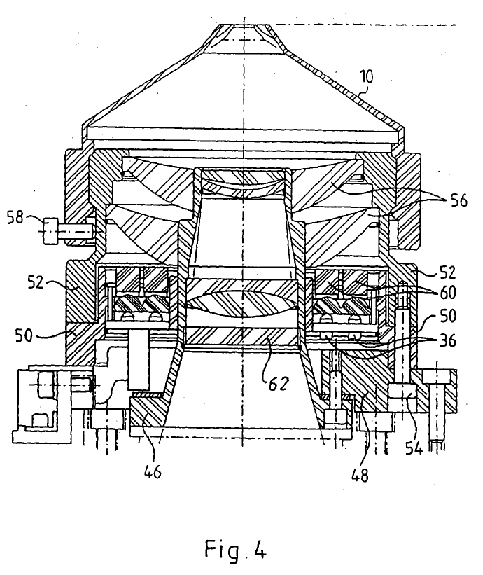

FIG. 4 is a cross-sectional view on an enlarged scale relative to FIGS. 1 and 2, of a cap usable in combination with the device of FIG. 3 and including light sources.

The present invention is applicable for example to a cell analyzer as disclosed in WO 01/88593. Reference is had to this document, more particularly to its FIG. 1 and to the corresponding description, for the general structure of this cell analyzer. What follows in the present description is given in reference to such a cell analyzer.

This analyzer is adapted particularly for the observation of the fluorescence of cell specimens contained in wells 2 of a titration plate 4, generally termed a culture plate.

As described in the mentioned document, this titration plate 4 is held in a movable frame 6 of a positioning plate mounted on a frame (not shown). This plate comprises a substantially flat bottom 8 which forms the bottom of the wells 2 containing the specimens to be observed. This bottom 8 bears against the sleeve 10 of generally truncated conical shape which itself is mounted on an objective 12 fixed relative to the frame of the analyzer. The present invention relates to this objective 12, which will be described in greater detail with reference to FIG. 3 in what follows of the description.

In FIG. 3 there will be also noted an illumination source 14 which sends light toward the titration plate 4, through the objective 12, this light being first reflected on a return prism 16. The camera 18 produces a representative image of the radiation emitted by the specimens located in the wells 2 of the titration plate 4. This radiation itself passes through the objective 12 and is directed toward the camera 18 by means of an inclined mirror 20. For simplification, the optical axes of the illumination source 14 and the camera 18 are shown in FIG. 1 as being parallel, whereas for example they can be perpendicular to each other. A focusing optics 19 shown very schematically by a double arrow is mounted in front of the camera 18.

The titration plate 4 is disposed horizontally, the bottom 8 thus constituting the lower surface of this plate. The wells 2 thus open through the upper surface of this plate. These are cylindrical wells of circular or square cross-section. The bottom of each well is substantially flat and horizontal. Different types of wells exist. The latest comprise 96, 384, 864 or 1536 wells. For plates comprising fewer wells, the diameter of these latter is of the order of 7 mm. The edges 22 of the titration plate 4 and the movable frame 6, having a peripheral flange 24, coacting as described in WO 01/88593 to permit the movement of the plate 4 in the direction of the observation axis, which is in this instance the vertical direction. The sleeve 10 forms a cross-member between the titration plate 4 and the objective 12. It is of generally truncated conical shape and its axis of revolution coincides substantially with the observation axis 26 which is also the axis of objective 12. As indicated in the mentioned document, the dimensions of this sleeve vary as a function of the objective 12 (and also the size of the wells 2 and of the titration plate 4).

As to the illumination source 14 and the camera 18, as well as the other means used to illuminate a well 2 of the titration plate 4 and to provide an image from the fluorescence of the cells contained in the wells 2, reference is had to the mentioned document.

The present invention relates more particularly to the objective 12 (which replaces the device bearing reference numeral 15 in WO 01/88593). This objective is shown on an enlarged scale in FIG. 3. In FIGS. 1 and 2, this objective is symbolized by two double arrows, each double arrow representing schematically a doublet of lenses. There is shown in FIG. 3 the bottom 8 of the titration plate 4.

In the description that follows, it will be considered that this titration plate is disposed in front of the objective 12 whilst the camera 18 is located to the rear of this objective 12. Thus, in the drawings, the front is upward whilst the rear is downward.

The illustrated objective 12 comprises two lens doublets. The front doublet comprises a plano-convex lens 28 and a divergent meniscal lens 30. The rear doublet is constituted by a plano-concave lens 32 and a bi-convex lens 34. The plano-convex lens 28 and plano-concave lens 32 preferably have a flat surface, but it could also if desired comprise a substantially flat surface, which is to say having for example a large radius of curvature.

All these lens are spherical lenses and are all centered on a same axis, the axis 26 of the objective 12. As indicated above, it is a vertical axis. It is substantially perpendicular to the bottom 8 of the titration plate 4, for better observation of this latter.

The first lens, which is to say the plano-convex lens 28, is made of a material trademarked Schott BK7 and has the following geometric characteristics:
Radius of curvature of the front surface: infinite
Radius of curvature of the rear surface: −31.23 mm±1 mm
Thickness of the center: 3 mm±1 mm
Diameter: 18 mm±2 mm

The material used for this lens has particularly an index of refraction n_{d} of 1.51680 (λ=587.6 nm) and an index of refraction nₑ of 1.51872 (λ=546.1 nm). The Abbe coefficient, which characterizes the dispersion of this material, is νₑ=64.17 (or ν_{d}=64.96).

The divergent meniscal lens 30 is a material known by the trademark Schott F2. It has particularly an index of refraction n_{d} of 1.62004 (λ=587.6 nm) and an index of refraction nₑ of 1.62408 (λ=546.1 nm). The Abbe coefficient, which characterizes the dispersion of this material, is νₑ=36.37 (or ν_{d}=36.11).

This divergent meniscal lens 30 has the following geometric characteristics:
Radius of curvature from the front surface: −17.693 mm±0.5 mm
Radius of curvature of the rear surface: −23.820 mm±1 mm
Thickness at the center: 1.5 mm±0.5 mm
Diameter: 18 mm±2 mm

The lenses 28 and 30 thus form a first doublet. This doublet can be un-cemented but it can also be in the form of a doublet un-cemented at the center but centered about its periphery. This latter solution facilitates the integration of this doublet in the frame of the analyzer.

The plano-concave lens 32 is made of a material sold under the mark Schott F2. It has the following geometric characteristics:
Radius of curvature of the front surface: infinite
Radius of curvature of the rear surface: 29.06 mm±1 mm
Thickness at the center: 2.2 mm±1 mm
Diameter: 24 mm±2 mm

The biconvex lens 34 is made of a material sold under the mark Schott BK7. This fourth lens has the following geometric characteristics:
Radius of curvature of the front surface: 29.06 mm±1 mm
Radius of curvature of the rear surface: −29.06 mm±1 mm
Thickness at the center: 5.6 mm±0.5 mm
Diameter: 24 mm±2 mm

These lenses 32 and 34 thus form a second doublet which is cemented. A concave surface of the biconvex lens 34 matches the concave surface of the plano-concave lens 32.

In this objective, the flat surfaces of the two doublets are oriented forwardly. The distance separating them is 22.6 mm (±2 mm).

The objective thus produced has a focal lens of 50 mm and a numerical opening NA=0.22.

The indicated materials are materials used at present for the production of lenses. Other materials can also be envisaged. However, they will preferably be chosen materials providing, relative to described materials, optical glass equivalent in terms of index of refraction and dispersion within a variance of ±3%.

Such an objective has a large angular field which permits it to see the entire bottom of a well 2 whilst being placed at a relatively short distance from this bottom.

It also has a spectral range capable of recovering the excitation fluorescence from the ultraviolet to near infrared. Given an excitation beginning in the blue, this objective permits covering the rest of the spectrum, namely from green to infrared, or in terms of wavelength, from 500 to 750 nm.

The described objective moreover permits very good resolution and wide opening (NA=0.22).

The dimensions indicated above are suitable to be able to collect in a single image the bottom of a well of a diameter of 7 mm. For different dimensions, the numerical values indicated above can all be multiplied by a same coefficient, which thus permits obtaining a similar device by homothetic transformation.

The objective described above has the advantage of being of low cost. It uses conventional optical materials that are used at present to produce lenses. The lenses used have no aspherical surfaces. Their production is thus easy and their cost is thus low. Finally, only four lenses are necessary to produce the objective described above. It will be noted that Gaussian objectives conventionally used themselves comprise at least six lenses.

To produce the image of the specimen, there is used focusing optics 19 associated with the camera 18. This focusing optics 19 can for example be a commercial objective of fixed focal length. There can also be used a zoom as focusing optics. This permits easily changing the size of the image and permits optimizing the use of the objective according to the invention. However, the use of a focusing zoom gives rise to labeling problems.

The objective 12 can also be used in associated with a crown of electroluminescent diodes 36 (FIG. 2). These diodes thus replace the luminous source 14. An individual lens is associated with each electroluminescent diode 36 so as to render the light emitted by all these diodes approximately parallel. A Fresnel lens 38 thus permits guiding the light from the diodes 36 toward the specimen to be observed. The electroluminescent diodes 36 used here are for example diodes similar to those described in European patent application published under No. 1 031 326.

Let it be supposed in FIG. 2 that the objective 12 is mounted in a conventional manner in a tubular housing (not shown). The presence of two flat surfaces in this objective facilitates the mounting in its tubular housing. A tubular support 40 then can cap the housing of objective 12. A set screw 42 is preferably provided to secure the tubular support 40 on thee housing of objective 12. This front surface, substantially radial relative to the axis 26 of the objective 12, carries the electroluminescent diodes 36. An annular plate 44, secured to the tubular support 40, surrounds this latter and is disposed orthogonally relative to the axis 26 of the objective 12. This annular plate 44 carries the sleeve 10. This latter is preferably made of metal and has on its internal surface means permitting the securement of the Fresnel lens 38.

The embodiment of this FIG. 2 permits having an excitation light cone surrounding the light cone from the fluorescence of the specimen to be observed. The excitation and fluorescence light cones are on the same axis. This permits having coaxial mounting of the camera and the objective 12.

FIG. 4 shows in greater detail on an enlarged scale the mounting of an optical device according to the invention in a third embodiment of a cell analyzer. This embodiment is similar to that shown in FIG. 2. Thus, there are here shown electroluminescent diodes 36 disposed in a crown. In this case, the diodes are disposed about two concentric crowns relative to the objective 12. This mounting in crown permit among other things having a coaxial mounting of the camera 18 and the objective 12.

The objection 12 is mounted in this embodiment within a tubular member 46. Shoulders are provided within this tubular member for the positioning of the flat surfaces of the plano-concave lens 32 and plano-convex lens 28. The tubular piece 46 is screwed onto a base 48. This latter carries a ring 50 carrying the electroluminescent diodes 36. This ring 50 is mounted concentrically relative to the tubular member 46.

On this first ring 50 is superposed a second ring 52. The same screws 54 simultaneously hold the two rings 50 and 52 on the base 48. The second base 52 carries two conventional lenses 56 pierced at their center to permit their concentric mounting about the tubular member 46. this lenses 56 concentrate the excitation light from the electroluminescent diodes 36 in the direction of the specimen to be observed. The sleeve 10 is fixed with the help of a set screw 58 on the second ring 52.

There will be noted in FIG. 4 the presence of a filter 60 disposed each time between a crown of a luminescent diode 36 and the lenses 56. These two filters 60 are mounted, in the illustrated embodiment, on the first ring 50.

In the device described above, the excitation light is provided at the periphery of the device and is concentrated toward the specimen to be observed, whilst the fluorescent light from this specimen passes through the device at its center. To stop reflections of the excitation light on the path of fluorescent emission and thus to avoid the excitation light reaching the camera, a filter 62 is disposed between the objective 12 and the camera. As can be seen in FIG. 4, this filter 62 is mounted in the tubular member 46, below the two doublets of the objective 12.

In this last embodiment, the electroluminescent diodes 36 emit at different wavelengths. Each crown of diodes corresponds to one wavelength. Different successive illuminations of the same specimen can be carried out at different wavelengths. There is thus selected for example a first crown of diodes emitting radiation of a wavelength of about 470 nm (±15 nm) and a second crown of diodes emitting radiation of a wavelength of about 635 nm (±15 nm). Each series of diodes can be provided in the number of two to fifty diodes, preferably between five and twenty. The power of each of these diodes is for example comprised between 1 and 10 mW.

Such an illumination device permits good illumination of the bottom of a well 2, and this over all its surface. Moreover, all the surface of the well is illuminated at the same time by the incident bundle of rays from the electroluminescent diodes 36. In this manner, all the surface of the specimen is excited simultaneously.

The electrical supply of the two series of diodes can alternate from one to the other. There are thus preferably produced two successive images which are then combined by computer with the help of software which carries out a pixel by pixel comparison for cytometric analysis.

The embodiments using diodes disposed in a crown are also advantageous because they permit causing the axes of illumination, observation and of the camera, to coincide.

The optical device according to the invention can be used with all types of analysis device of fluorescent light. In a simple embodiment, there is used a color camera, TriCCD, or with Bayer filters, for example. In a preferred embodiment, a carousel with filters permits acquiring successive images in several different spectral channels, and is disposed behind the optical device according to the invention. This carousel with filters can be disposed immediately before or after the stopping filter 62. In a preferred modification, the carousel with filters is replaced by a liquid crystal filter, whose spectral properties are controllable electronically.

In another modified embodiment, a 45° dichroic mirror, which returns a portion of the light to the second camera, is installed in the path of the fluorescence light. The images are thus produced simultaneously. The apparatus thus outfitted can be used for measurements of energy transfer between a donor and an acceptor within the cell, so-called FRET (Fluorescence Resonance Energy Transfer).

The present invention is not limited to the embodiments described above by way of non-limiting example. It also concerns all the modifications within the scope of those skilled in the art, within the scope of the following claims.

The optical device described above is integrated with a cellular analyzer providing views automatically and analyzing the obtained images with the help of a computer and software. Of course, there is no departure from the scope of the invention if this objective is mounted in a manual cellular analyzer in which a user manually moves a titration plate before the objective and directly observes the specimens disposed in this titration plate. The optical device can also be used in any apparatus of the microscope type, with applications particularly in the field of biology but also for example in electronics.

The optical device according to the invention can be used with all types of illumination sources. It can for example be a lamp, a laser, electroluminescent diodes, etc . . . It is also conceivable to omit the illumination source and/or to provide an external source.

The same is true for the camera, all types of camera being adapted to be used. It is also possible not to have a camera at all, as for example in the case of analysis by eye.

1. Optical device (12) adapted particularly for the observation of specimens on a support (4) in the field of biology, comprising a front surface located on the side of the specimen or the like, to be observed and a rear surface oriented toward acquisition means (18, 19) of an image or a user,
characterized in that it comprises a combination of four aligned lenses and in that the lenses are disposed in the following order from front to rear: a plano-convex lens (28), a divergent meniscal lens (30), a plano-concave lens (32) and a bi-convex lens (44), the plano-concave lens (32) and plano-convex lens (48) respectively being such as each to have on the one hand a substantially flat surface and on the other hand a respective concave or convex surface.

2. Optical device according to claim 1, characterized in that the lenses are assembled as two doublets, a front doublet with the plano-convex lens (28) and a divergent meniscal lens (30) and a rear doublet with the plano-concave lens (32) and the biconvex lens (34).

3. Optical device according to claim 2, characterized in that the rear doublet is a cemented doublet for which the front radius of curvature of the biconvex lens (34) corresponds to the radius of curvature of the rear spherical surface of the plano-concave lens (32), and in that the two lenses of each doublet are made of materials having different indices of refraction.

4. Optical device according to claim 2, characterized in that the front doublet is an uncemented doublet.

5. Optical device according to claim 2, characterized in that the front doublet is an uncemented doublet at the center but cemented about its periphery.

6. Optical device according to claim 1, characterized in that the two lenses (30, 32) located at the center of the optical device have an index of refraction greater than the index of refraction of the lenses (28, 34) located at the outside of the optical device (12).

7. Optical device according to claim 1, characterized in that the plano-convex lens (28) has a rear surface whose radius of curvature is comprised between −30 and −32.5 mm and a front substantially flat surface, a diameter comprised between 20 and 25 mm as well as the thickness at the center comprised between 2 and 4 mm, in that the divergent meniscal lens (30) has a rear surface whose radius of curvature is comprised between −22.5 and −25 mm and a front surface whose radius of curvature is comprised between −17 and −18.5 mm, a diameter substantially equal to the diameter of the plano-convex lens as well as a thickness at the center comprised between 1 and 2 mm, in that the plano-concave lens (32) has a rear surface whose radius of curvature corresponds to the radius of curvature of the front surface of the biconvex lens (34), a diameter substantially identical to the diameter of the biconvex lens (34) as well as a thickness at the center comprised between 1 and 3.5 mm, in that the rear biconvex lens (34) has a rear surface whose radius of curvature is comprised between −28 and −30 mm and a front surface whose radius of curvature is comprised between 28 and 30 mm, a diameter comprised between 22 and 26 mm as well as a thickness at the center comprised between 4 and 7 mm, and in that the distance between the flat surfaces of the plano-concave lens (32) and the plano-convex lens (28) is comprised between 20 and 25 mm,
all the values indicated for this device being adapted to be multiplied by a same coefficient to obtain a similar device by homothetic transformation.

8. Optical device according to claim 1, characterized in that it moreover comprises electroluminescent diodes (36) disposed in a crown about its axis as well as a Fresnel lens (38) interposed between the diodes (36) and the specimen, or the like, to be observed.

9. Observation or analysis device for one or several specimens disposed on a support (4), particularly a plate, comprising an observation objective (12) for at least one portion of a specimen along an observation axis (26) from an observation surface of the support, a positioning plate of the supported adapted to ensure relative movement between the support (4) and the axis of observation (26) in a plane perpendicular to the axis of observation, whilst leaving free the vertical movement, illumination means (14) of at least a portion of the specimen and acquisition means (18) of an image at the objective outlet,
characterized in that the observation objective comprises an optical device (12) according to claim 1.

10. Observation device according to claim 9, characterized in that the acquisition means of an image comprise an objective with fixed focal length as the focusing optics (19).

11. Observation device according to claim 9, characterized in that the acquisition means of an image comprise a zoom as the focusing optics (19).

12. Observation device according to claim 9, characterized in that it comprises behind the optical device a filtration device having variable spectral properties.

13. Observation device according to claim 9, characterized in that it comprises on the path of the fluorescence light a dichroic mirror returning a portion of this light towards second observation means.

14. Optical device according to claim 3, characterized in that the front doublet is an uncemented doublet.

15. Optical device according to claim 3, characterized in that the front doublet is an uncemented doublet at the center but cemented about its periphery.

16. Observation device according to claim 10, characterized in that it comprises behind the optical device a filtration device having variable spectral properties.

17. Observation device according to claim 11, characterized in that it comprises behind the optical device a filtration device having variable spectral properties.

18. Observation device according to claim 10, characterized in that it comprises on the path of the fluorescence light a dichroic mirror returning a portion of this light towards second observation means.

19. Observation device according to claim 11, characterized in that it comprises on the path of the fluorescence light a dichroic mirror returning a portion of this light towards second observation means.

20. Observation device according to claim 12, characterized in that it comprises on the path of the fluorescence light a dichroic mirror returning a portion of this light towards second observation means.
